(19) United States
(12) Patent Application Publication
(10) Pub. No.: US 2017/0324707 A1
(43) Pub. Date: Nov. 9, 2017

(54) NETWORK SERVICE PROVIDER ARCHITECTURE WITH INTERNET-ROUTE-FREE CONTROL PLANE

(71) Applicant: AT&T Intellectual Property I, L.P., Atlanta, GA (US)

(72) Inventors: Dimitri Krinos, Tampa, FL (US); Gary R. Flack, Smithton, IL (US); Adrian Cepleanu, Anthem, AZ (US)

(21) Appl. No.: 15/145,250

(22) Filed: May 3, 2016

(51) Int. Cl. H04L 29/06; H04L 12/741; H04L 12/46; H04L 12/723

(52) U.S. Cl. CPC H04L 63/0227; H04L 63/1441; H04L 63/0428; H04L 63/029; H04L 63/0272; H04L 12/4604; H04L 45/50; H04L 12/4641; H04L 12/4633; H04L 45/745

(57) ABSTRACT

In a network service provider environment, the service provider infrastructure is protected by separating internet routing from the default context and placing it within a virtual private network context. Packets received from the public internet are encapsulated for transit through the service provider infrastructure based on the packet source being the public internet. MPLS VPN technology may be used in the encapsulation technique. The architecture removes the public part of the underlay network and tunnels it through a new overlay. The result is that internet traffic is contained in a separate routing domain, hiding the network infrastructure from that untrusted service traffic that transits the network.

### TECHNICAL FIELD

Embodiments of the present disclosure relate to providing commercial internet protocol networks. Specifically, the disclosure relates to protecting the physical and virtual network infrastructure of a provider network from internet transit traffic.

### BACKGROUND

Protecting network elements in a provider network from attacks embedded in the internet traffic transiting the network is extremely complex and costly because the same routing domain is used for internet traffic as is used for customer/service and control/management traffic. The problem is exacerbated as network functions are virtualized, causing the perimeter to blur even further as the concept of inside versus outside erodes.

As more physical network functions are replaced with virtual network functions, implementation of the legacy network perimeter using a packet filtering transport network becomes significantly more complex, error prone, and less scalable. The migration of deep packet inspection required for filtering into the virtualization layer is also costly in terms of memory and CPU.

Provider network elements are typically protected by implementing perimeters surrounding all devices using packet filtering configured in the transport network. Those perimeters are costly to operate and require their own design components in virtually every network function in a provider network. A security perimeter tax is effectively imposed on every project that touches the internet. Internet traffic currently permeates all layers of network elements.

### BRIEF DESCRIPTION OF THE DRAWINGS

The present disclosure can be readily understood by considering the following detailed description in conjunction with the accompanying drawings, in which:

FIG. 1A is a diagrammatic representation of a prior art internet protocol network architecture.

FIG. 1B is a diagrammatic representation of another prior art internet protocol network architecture.

FIG. 2 is a diagrammatic representation of an internet protocol network architecture according to aspects of the present disclosure.

FIG. 3 is a diagram showing interactions among layers of an existing network services provider network.

FIG. 4 is a diagram showing interactions among layers of a network services provider network in accordance with aspects of the present disclosure.

FIG. 5 is a flow diagram showing a method in accordance with aspects of the present disclosure.

To facilitate understanding, identical reference numerals have been used, where possible, to designate identical elements that are common to the figures.

### DETAILED DESCRIPTION OF EXEMPLARY EMBODIMENTS

Presently disclosed is a method and network architecture for protecting a network provider infrastructure (both physical and virtual network functions) by isolating internet traffic into a separate container. By placing internet traffic into that container, an architecturally constructed compartmentalization or separation is introduced between different trust/sensitivity levels. Such compartmentalization has never existed in a provider network.

Traditional carrier routers forward internet traffic within their default routing context, while virtual private network (VPN) traffic is isolated within separate routing contexts commonly called virtual routing and forwarding contexts (VRFs). The presently disclosed architecture protects the service provider infrastructure by separating internet routing from the default context and placing it within a virtual private network context. While that technique is commonly employed for private internetworks, it is not employed for isolating the public internet traffic.

The disclosed solution is transparent outside the service provider boundary. While the multiprotocol label switching (MPLS) VPN technology that may be used in the presently disclosed architecture is known, it is typically used as an overlay on top of the internet routing domain. The architecture removes the public part of the underlay network and places it in a new overlay. The result is that internet routed traffic is contained in a separate routing domain, hiding the network infrastructure from that untrusted service traffic that transits the network.

Embodiments of the present disclosure include a provider network for providing network services. The network includes a plurality of interconnected backbone core (CBB) devices, the backbone core devices providing backbone infrastructure functionality in the provider network including exchanging network infrastructure messages via an infrastructure routing context.

The provider network additionally includes a plurality of provider edge devices interconnected with the backbone core devices and interconnected with a public internet, each provider edge device comprising one or more processors configured to execute instructions. The instructions cause the provider edge device to perform operations comprising: receiving a data packet; determining that the data packet is an internet transit data packet, and, based solely on determining that the data packet is an internet transit data packet, transmitting the data packet through the backbone core devices to a destination identified by a packet header of the data packet, via a dedicated internet isolation routing context securely isolated from the infrastructure routing context.

Further embodiments of the disclosure include a method for routing a data packet by a provider edge device connected to a provider backbone network. A determination is initially made that the data packet is an internet transit data packet.

Based on that determination, the data packet is transmitted via a dedicated internet isolation routing context. That includes applying an encapsulation protocol to the internet data packet to create an encapsulated data packet, which isolates the dedicated internet isolation routing context from an infrastructure routing context. Transmitting the data packet via the dedicated internet isolation routing context also includes transmitting the encapsulated data packet to the provider backbone network for tunneled transport through the provider backbone network via the infrastructure routing context, the infrastructure routing context also being used in exchanging network infrastructure messages within the provider backbone network. As used herein, “tunneled transport” means the transport of traffic via an underlying network using a tunneling protocol that isolates the transported traffic from the underlying network. One example of tunneled transport is the use of an MPLS protocol to instantiate a VPN tunnel in an IP network. One skilled in the art will recognize that other routing context technologies may alternatively be used to implement tunneled transport.

In further embodiments of the disclosure, a computer-readable storage device has stored thereon computer readable instructions for routing a data packet by a provider edge device connected to a provider backbone network. Execution of the computer readable instructions by a processor causes the processor to perform operations comprising: determining that the data packet is an internet transit data packet, and, based on the determining that the data packet is an internet transit data packet, transmitting the internet data packet via a dedicated internet isolation routing context. Transmitting the data packet via the dedicated internet isolation routing context includes applying an encapsulation protocol to the data packet to create an encapsulated data packet. Applying the encapsulation protocol to the internet data packet isolates the dedicated internet isolation routing context from an infrastructure routing context. Transmitting the data packet via the dedicated internet isolation routing context also includes transmitting the encapsulated data packet to the provider backbone network for tunneled transport through the provider backbone network via the infrastructure routing context, the infrastructure routing context also being used in exchanging network infrastructure messages within the provider backbone network.

Software defined networking (SDN) has changed the security perimeter that a network provider must maintain. The commercial IP network's first layer of security—the “perimeter”—has been based upon an IP address plan defining a boundary between inside and outside. As more of the physical network functions are replaced with virtual network functions, implementation of a legacy network perimeter using packet filtering becomes significantly more complex, error prone, and less scalable. Even with increased access control list (ACL) automation, implementation becomes less verifiable over time.

The present disclosure provides an architecture and method for protecting the physical and virtual network control and management functions by isolating internet transit traffic into a separate container. As the term is used in the present disclosure, a public internet transit packet is defined as a packet received at the provider edge from a network services customer, or a packet received from an upstream peering edge. By putting the internet transit traffic into a VPN, an architecturally constructed compartmentalization/separation is introduced between different trust/sensitivity levels, facilitating the development of virtualized networking.

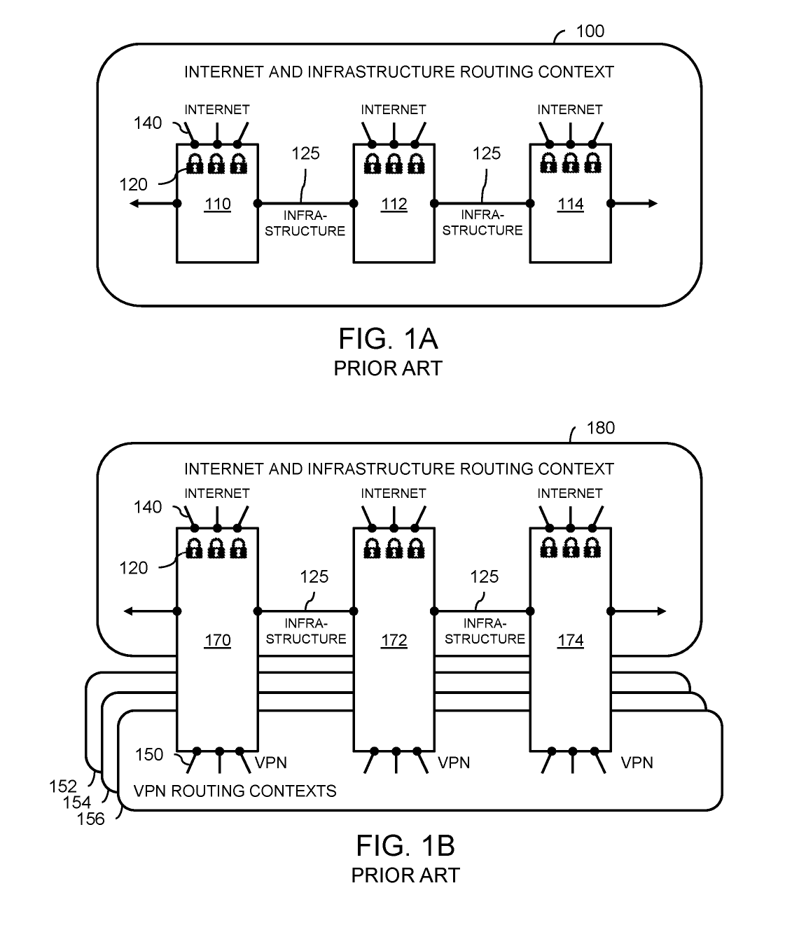

The diagrams of FIGS. 1A and 1B illustrate traditional techniques for protecting network provider infrastructure from internet transit traffic. A single internet and infrastructure routing context 100, shown in FIG. 1A, was originally used by network service providers. The devices 110, 112, 114 support only the single routing context. The routing context includes internet transit traffic 140 and infrastructure 125. The infrastructure 125 is restricted using locking techniques 120 such as ACLs. Each connection to internet transit traffic 140 is locked separately.

As shown in FIG. 1B, MPLS VPN technology 150 has permitted the creation of closed user groups such as the dedicated VPN routing contexts 152, 154, 156. Devices 170, 172, 174 support multiple routing contexts including the default context 180 and the VPN routing contexts 152, 154, 156. The infrastructure 125 and internet service 140, however, still use routable IP addresses in the single routing context 180.

Because the architecture shown in FIG. 1B evolved from the original network provider architecture shown in FIG. 1A, several issues arise with its use. There is no separation between internet service 140 and network infrastructure 125; instead, a single routing context 180 services both internet service and infrastructure. For that reason, the infrastructure 125 is reachable from the internet and must be locked out. An ACL-based security perimeter 120 must be used to control access to the infrastructure 125.

As the internet has grown and devices and functions have become virtualized, address fragmentation has caused increases in the size and complexity of the ACLs 120. That has resulted in the maintenance of those ACLs becoming more complex, to the point where it is virtually impossible to assure the integrity of the perimeter.

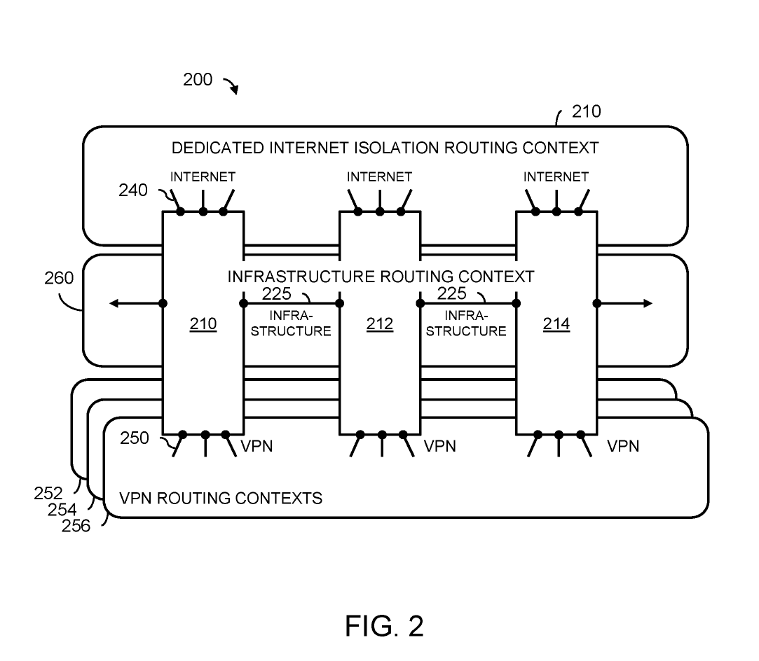

In the presently disclosed architecture, an example 200 of which is shown in FIG. 2, internet service 240 is placed in its own dedicated internet isolation routing context 210 using MPLS VPN technology or another tunneled transport technology. The network provider global routing table is used only for network infrastructure 225 within an exclusive infrastructure routing context 260. No other traffic is transported within that routing context. While the dedicated internet isolation routing context 210 may utilize a VPN or another tunneling technique layered on the infrastructure routing context 260, the infrastructure 225 is unreachable from the dedicated internet isolation routing context 210. That arrangement restores architectural governance for access control points.

The dedicated internet isolation routing context 210 is similar to the VPN routing contexts 252, 254, 256 in that each of those routing contexts separates traffic transported within those contexts from other traffic within the provider network. The purpose of the dedicated internet isolation routing context 210, however, is different from the purpose of the VPN routing contexts 252, 254, 256. While the VPN routing contexts 252, 254, 256 protect the data transported within those contexts from traffic and devices outside those contexts, the dedicated internet isolation routing context 210 protects all the data provider traffic and devices outside that context from the traffic transported within the dedicated internet isolation routing context 210.

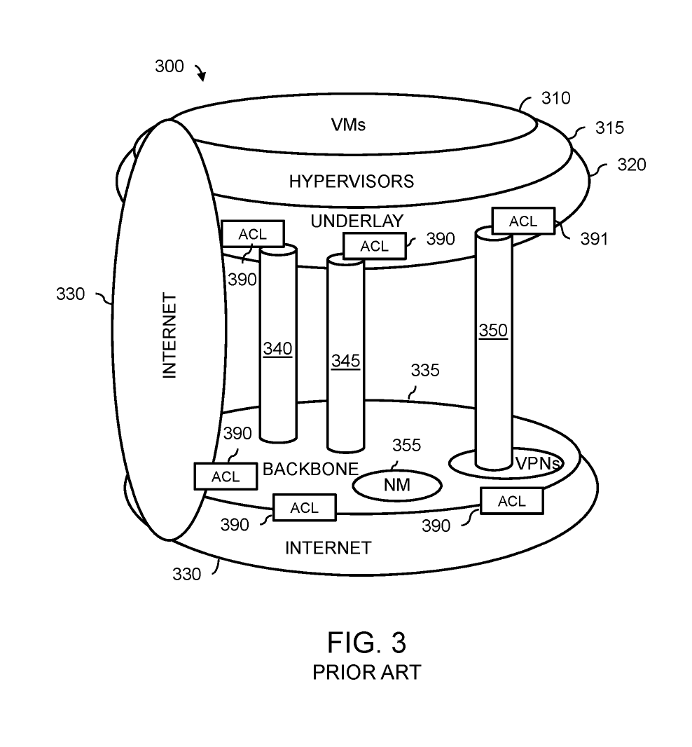

As can be seen in the representation 300 of a present-day provider network, shown in FIG. 3, the internet 330 permeates all layers of the network including the virtual machine layer (VM) 310, the hypervisor layer 315, the underlay 320 and the backbone 335. Protection against internet traffic must be implemented at all edges. In the example shown, a security perimeter is established in the form of multiple access control lists 390 separating backbone infrastructure 335, 340, 345 and network management infrastructure 355 from internet transit traffic. ACLs such as ACL 391 are also used in protecting traffic contained in VPNs 350. Each of the ACLs 390, 391 must be individually designed and separately maintained to protect the particular network element with which it is associated. The virtual machines 310 and hypervisors 315 are each encumbered because of the necessity to protect themselves from internet transit traffic.

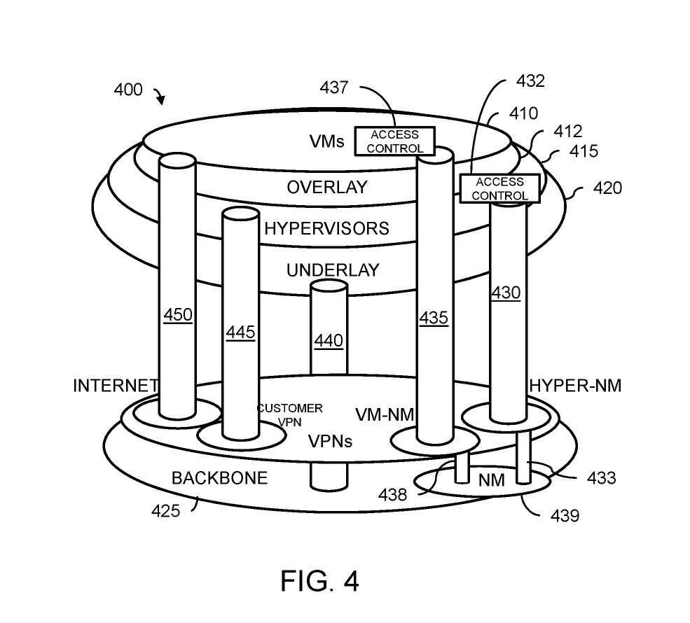

In the presently described provider network architecture, the network control/management plane is separated from the internet transit traffic. As shown in the network representation 400 of FIG. 4, internet transit traffic is placed into a separate dedicated internet isolation routing context 450. Specifically, the underlay 420 does not contain a public portion as does the underlay 320 of FIG. 3. Instead, in the case where the VM 410 touches the internet, public internet transit traffic is tunneled through a new overlay 412. By doing so, the attack surface exposed to either upstream internet peering edges or to network services customers is minimized. Virtual machines that do not touch the internet are automatically protected by the presently disclosed architecture, and need not protect themselves.

Multiple VPNs 430, 435, 440, 445 are used to segregate traffic in the network into separate contexts. For example, hypervisors and VMs are pushed into the control VPNs 430, 435, respectively. Access to those routing contexts may be controlled by access control arrangements 432, 437 such as virtual infrastructure perimeter regulators.

Network management for the backbone 425 is performed via a privileged network manager (NM) 439 within the default routing context. All other management traffic, including management traffic to the VMs 410 and hypervisors 415, is placed in separate routing contexts. Additional separate routing contexts 433, 438 are used in distributing management traffic to the correct control VPNs 430, 435.

The decomposed domains shown in FIG. 4 therefore replace the perimeter of ACLs 390, 391 shown in FIG. 3 to isolate the provider network infrastructure from internet transit traffic.

The presently described network architecture greatly simplifies defensive measures taken against distributed denial of service (DDOS) attacks. In today's provider networks, rerouting traffic to DDOS scrubbers requires maintaining one or more separate network paths or delivery VPNs to deliver traffic to or from the scrubbers. The diversion and reinjection of the traffic avoids a routing loop, but adds complexity to the system. Further, many ongoing changes in the network transport (or new edge introduction) affect the delivery VPNs, requiring additional development work to maintain the clean or scrubbed path.

The complexity of DDOS defense is greatly reduced by the presently described architecture. The requirement of a delivery VPN is eliminated, because both scrubbed and unscrubbed traffic are carried by the dedicated internet isolation routing context. It is possible to send traffic on the labeled tunnels end to end. No routing loops occur with that architecture and no dedicated, separate path is therefore needed.

The presently described architecture reduces additional security vulnerabilities in accordance with basic cyber-security best practices. For example, the technique maintains economy of mechanism, keeping systems simple and small, and therefore more readily defensible.

By nature, the design includes fail-safe defaults. That means that the default access permission is denial, and the access control devices 432, 437 (FIG. 4) must explicitly permit access. There is complete mediation: no one is able to bypass security measures. The design is an open design, and does not count on secrecy to provide protection.

The system follows a least privilege principle wherein users are granted only the minimum necessary level of access and are able to access only the information and resources that are necessary for their legitimate purpose. The system furthermore has good psychological acceptability. Users of the proposed system are not expected to do what is inconvenient by securing the network from the internet. In contrast, provider networks today rely on users to place individual locks on devices to protect the infrastructure.

The presently described architecture provides other benefits to the network services provider. The architecture eliminates the need for individual access control lists or other access control mechanisms to protect the provider infrastructure. Many millions of such filters are currently in use for perimeter protection.

The proposed architecture furthermore enables scalable deployment of a cloud-based provider network by simplifying the definition and maintenance of the network perimeter. Devices on the perimeter are not required to protect the overall infrastructure; instead, those devices must protect only themselves.

The presently described system frees up valuable compute resources and increases the performance of a cloud-based provider network. For example, TCAM memory previously used for ACL processing on physical network functions (PNFs) is available for other uses. Similarly, memory and CPU usage on virtual network functions (VNFs) is decreased due to simplification. Further, edge routers are better utilized by increased sharing.

Network security and forwarding performance are both improved in comparison with a typical provider network architecture. The isolated nature of the network infrastructure reduces attack surfaces significantly. The proposed architecture enables creation of a virtual perimeter to meet future security needs. There are fewer rules and therefore fewer exceptions, resulting in increased security and increased simplicity.

The presently described system provides operational simplicity. A single model is used for all customer connections, because all transit traffic is transported in a VPN. There is minimal filtering of customer traffic. Infrastructure expansion is decoupled from updating the entire perimeter, enhancing scalability.

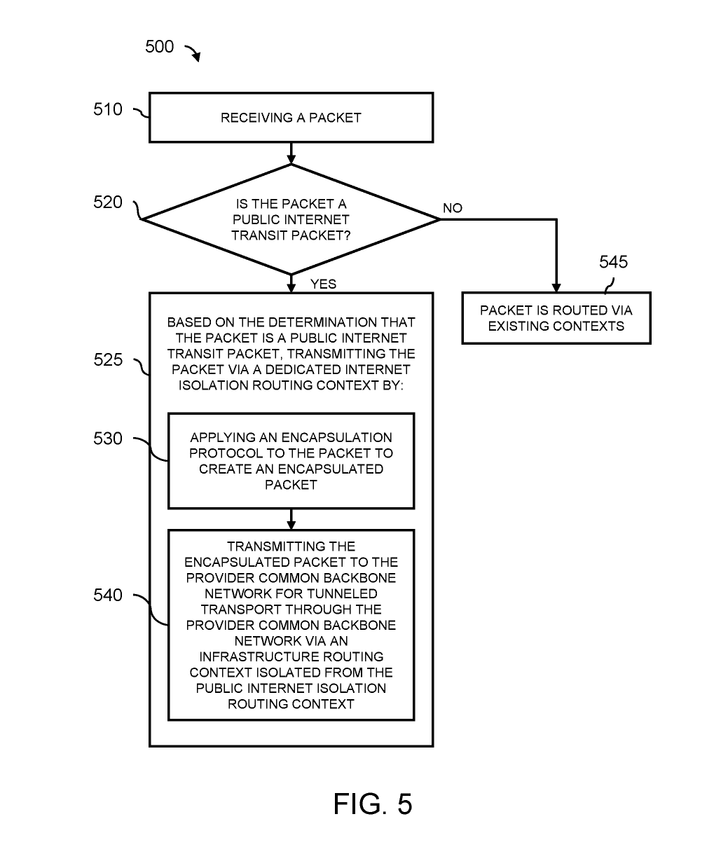

A method for routing an internet data packet by a provider edge device connected to a provider backbone network will now be described with reference to the block diagram 500 of FIG. 5. The provider backbone network may include virtual devices.

After receiving a packet at operation 510, a determination 520 is made whether the packet is a public internet transit packet. If the packet is not a public internet transit packet, then the packet is routed 545 via existing contexts. If it is determined that the packet is a public internet transit packet, then, based on that determination, the packet is transmitted at operation 525 via a dedicated internet isolation routing context.

To transmit the packet via the dedicated internet isolation routing context, an encapsulation protocol is applied at operation 530 to the packet to create an encapsulated packet. The encapsulation protocol may, for example, include a multiprotocol label switching packet encapsulation technique.

The encapsulated data packet is then transmitted to the provider backbone network at operation 540 for tunneled transport via an infrastructure routing context. The infrastructure routing context is also used in exchanging network infrastructure messages within the provider backbone network. By applying the encapsulation protocol to the internet data packet, the dedicated internet isolation routing context is isolated from the infrastructure routing context.

A default status for all data packets from the public internet transmitted through the plurality of interconnected backbone core devices is a status denying access to the backbone core devices. Because transit traffic from the public internet is isolated from the infrastructure routing context, devices of the provider backbone network may be interconnected without using packet filtering perimeters.

The method may also include filtering DDOS attack traffic using a traffic scrubber, wherein routes to and from the traffic scrubber utilize the dedicated internet isolation routing context.

The hardware and the various network elements used in implementing the above-described processes and systems comprise one or more processors, together with input/output capability and computer readable storage devices having computer readable instructions stored thereon that, when executed by the processors, cause the processors to perform various operations. The processors may be dedicated processors, or may be mainframe computers, desktop or laptop computers or any other device or group of devices capable of processing data. The processors are configured using software according to the present disclosure.

Each of the hardware elements also includes memory that functions as a data memory that stores data used during execution of programs in the processors, and is also used as a program work area. The memory may also function as a program memory for storing a program executed in the processors. The program may reside on any tangible, non-volatile computer-readable storage device as computer readable instructions stored thereon for execution by the processor to perform the operations.

Generally, the processors are configured with program modules that include routines, objects, components, data structures and the like that perform particular tasks or implement particular abstract data types. The term “program” as used herein may connote a single program module or multiple program modules acting in concert. The disclosure may be implemented on a variety of types of computers, including routers, personal computers (PCs), hand-held devices, multi-processor systems, microprocessor-based programmable consumer electronics, network PCs, mini-computers, mainframe computers and the like, and may employ a distributed computing environment, where tasks are performed by remote processing devices that are linked through a communications network. In a distributed computing environment, modules may be located in both local and remote memory storage devices.

An exemplary processing module for implementing the methodology above may be stored in a separate memory that is read into a main memory of a processor or a plurality of processors from a computer readable storage device such as a ROM or other type of hard magnetic drive, optical storage, tape or flash memory. In the case of a program stored in a memory media, execution of sequences of instructions in the module causes the processor to perform the process operations described herein. The embodiments of the present disclosure are not limited to any specific combination of hardware and software.

The term “computer-readable medium” as employed herein refers to a tangible, non-transitory machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. The terms “tangible media” and “non-transitory media” each exclude transitory signals such as propagated signals, which are not tangible and are not non-transitory. Cached information is considered to be stored on a computer-readable medium. Common expedients of computer-readable media are well-known in the art and need not be described in detail here.

The described solution provides significant benefits in cost and complexity reduction in all aspects of a provider network. It significantly raises the security posture of the internet service provider (ISP) by reducing attack surfaces and moving the provider network from an open to a closed stance facing the internet. The solution additionally allows the network provider to control and maintain the network using the same redundant physical connectivity while maintaining architectural compartmentalization (separation) between different trust levels.

In addition to security benefits, moving the internet routes into a separate context empowers the virtual edge to control its own network security policy in a distributed fashion versus the current centralized and monolithic approach. Without that approach, the virtual edge is permanently encumbered by the existing perimeter and cannot scale out to the expected levels.

The forgoing detailed description is to be understood as being in every respect illustrative and exemplary, but not restrictive, and the scope of the disclosure herein is not to be determined from the description, but rather from the claims as interpreted according to the full breadth permitted by the patent laws. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. It is to be understood that various modifications will be implemented by those skilled in the art, without departing from the scope and spirit of the disclosure.

What is claimed is:

1. A provider network for providing network services, comprising:
a plurality of interconnected backbone core devices, the backbone core devices providing backbone infrastructure functionality in the provider network including exchanging network infrastructure messages via an infrastructure routing context;
a plurality of provider edge devices interconnected with the backbone core devices and connected for receiving internet transit traffic, each provider edge device comprising one or more processors configured to execute instructions causing the provider edge device to perform operations comprising:
receiving a data packet;
determining that the data packet is an internet transit data packet; and
based solely on determining that the data packet is an internet transit data packet, transmitting the data packet through the backbone core devices to a destination identified by a packet header of the data packet, via a dedicated internet isolation routing context securely isolated from the infrastructure routing context.

2. The provider network of claim 1, wherein the dedicated internet isolation routing context comprises a tunneling protocol whereby internet transit data packets are encapsulated and then transmitted over the infrastructure routing context.

3. The provider network of claim 2, wherein the tunneling protocol comprises a multiprotocol label switching packet encapsulation technique.

4. The provider network of claim 1, wherein the infrastructure routing context is a default routing context of the provider network, and the dedicated internet isolation routing context is a virtual private network context of the provider network that is separate from, and is an overlay of, the default routing context.

5. The provider network of claim 1, wherein the provider edge devices are connected for receiving internet transit traffic without using packet filtering perimeters to deny access to the infrastructure routing context.

6. The provider network of claim 1, wherein the backbone core devices include virtual devices.

7. The provider network of claim 1, further comprising a DDOS upstream filtering system wherein routes to and from a traffic scrubber utilize the dedicated internet isolation routing context.

8. The provider network of claim 1, wherein a default status for internet transit data packets transmitted through the plurality of interconnected backbone core devices and provider edge devices is a status denying access to the backbone core devices.

9. A method for routing a data packet by a provider edge device connected to a provider backbone network, comprising:
determining that the data packet is an internet transit data packet;
based on the determining that the data packet is an internet transit data packet, transmitting the data packet via a dedicated internet isolation routing context, including:
applying an encapsulation protocol to the data packet to create an encapsulated data packet; and
transmitting the encapsulated data packet to the provider backbone network for tunneled transport through the provider backbone network via an infrastructure routing context, the infrastructure routing context also used in exchanging network infrastructure messages within the provider backbone network, wherein applying the encapsulation protocol to the data packet isolates the dedicated internet isolation routing context from the infrastructure routing context.

10. The method of claim 9, wherein the encapsulation protocol comprises a multiprotocol label switching packet encapsulation technique.

11. The method of claim 9, wherein the provider edge devices are connected for receiving internet transit data packets without using packet filtering perimeters to deny access to the infrastructure routing context.

12. The method of claim 9, wherein the provider backbone network comprises virtual devices.

13. The method of claim 9, further comprising:
filtering DDOS attack traffic using a traffic scrubber wherein routes to and from the traffic scrubber utilize the dedicated internet isolation routing context.

14. The method of claim 9, wherein a default status for internet transit data packets transmitted through the provider backbone network is a status denying access to devices of the provider backbone network.

15. A computer-readable storage device having stored thereon computer readable instructions for routing a data packet by a provider edge device connected to a provider backbone network, wherein execution of the computer readable instructions by a processor causes the processor to perform operations comprising:
determining that the data packet is an internet transit data packet;
based on the determining that the data packet is an internet transit data packet, transmitting the data packet via a dedicated internet isolation routing context, including:
applying an encapsulation protocol to the data packet to create an encapsulated data packet; and
transmitting the encapsulated data packet to the provider backbone network for tunneled transport through the provider backbone network via an infrastructure routing context, the infrastructure routing context also used in exchanging network infrastructure messages within the provider backbone network, wherein applying the encapsulation protocol to the data packet isolates the dedicated internet isolation routing context from the infrastructure routing context.

16. The computer-readable storage device of claim 15, wherein the encapsulation protocol comprises a multiprotocol label switching packet encapsulation technique.

17. The computer-readable storage device of claim 15, wherein the provider edge devices are connected for receiving internet transit data packets without using packet filtering perimeters to deny access to the infrastructure routing context.

18. The computer-readable storage device of claim 15, wherein the provider backbone network comprises virtual devices.

19. The computer-readable storage device of claim 15, further comprising:
filtering DDOS attack traffic using a traffic scrubber wherein routes to and from the traffic scrubber utilize the dedicated internet isolation routing context.

20. The computer-readable storage device of claim 15, wherein a default status for internet transit data packets transmitted through the provider backbone network is a status denying access to devices of the provider backbone network.
